(19) United States
(12) Patent Application Publication
(10) Pub. No.: US 2014/0201442 A1
(43) Pub. Date: Jul. 17, 2014

(54) CACHE BASED STORAGE CONTROLLER

(71) Applicant: LSI CORPORATION, Milpitas, CA (US)

(72) Inventors: Jeevanandham Rajasekaran, Manapparai (IN); Ankit Sihare, Bangalore (IN)

(73) Assignee: LSI CORPORATION, Milpitas, CA (US)

(21) Appl. No.: 13/741,465

(22) Filed: Jan. 15, 2013

(51) Int. Cl. G06F 12/08

(52) U.S. Cl. CPC G06F 12/0806
USPC 711/119

(57) ABSTRACT

Systems and techniques for continuously writing to a secondary storage cache are described. A data storage region of a secondary storage cache is divided into a first cache region and a second cache region. A data storage threshold for the first cache region is determined. Data is stored in the first cache region until the data storage threshold is met. Then, additional data is stored in the second cache region while the data stored in the first cache region is written back to a primary storage device.

### FIELD OF THE INVENTION

The present disclosure is related to systems and techniques for improving write cliff handling in cache based storage controllers.

### BACKGROUND

A cache based storage controller can operate using a single cache pool, where one area (e.g., cache write region) is used for storing data to be written back to primary storage. Generally, a cache based storage controller allows writing to an entire write region (e.g., until the write region is full or substantially full). Then, the data in the write region is written back (flushed) to primary storage such as a hard disk. In this configuration, the storage controller continues to transmit write back data to the cache write region, even when there is no remaining space in the cache write region (e.g., when flushing occurs). When a cache storage controller writes data to a single write cache region and is unaware of the amount of free storage space in the write cache region, write latency increases and write performance decreases (e.g., for both sequential and random storage segments). Further, when the write cache region is filled (or substantially filled) before a periodic flush time, further write back operations will be halted between, for example, storage controller memory and the cache pool during flushing, which negatively impacts write performance.

### SUMMARY

Systems and techniques for continuously writing to a secondary storage cache are described. A data storage region of a secondary storage cache is divided into a first cache region and a second cache region. A data storage threshold for the first cache region is determined. Data is stored in the first cache region until the data storage threshold is met. Then, additional data is stored in the second cache region while the data stored in the first cache region is written back to a primary storage device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE FIGURES

Other embodiments of the disclosure will become apparent.

FIG. 1 is a block diagram illustrating a system including a controller communicatively coupled with primary storage and operatively coupled with a secondary storage cache, where the controller is configured to divide data storage in the secondary storage cache into multiple storage regions in accordance with example embodiments of the present disclosure.

FIG. 2 is a graph illustrating a number of input/output operations per second versus time in minutes for one example secondary storage cache using a single cache pool and another secondary storage cache using multiple storage cache regions in accordance with example embodiments of the present disclosure.

FIG. 3 is a flow diagram illustrating a method for operating a secondary storage cache comprising multiple storage cache regions in accordance with example embodiments of the present disclosure.

### DETAILED DESCRIPTION

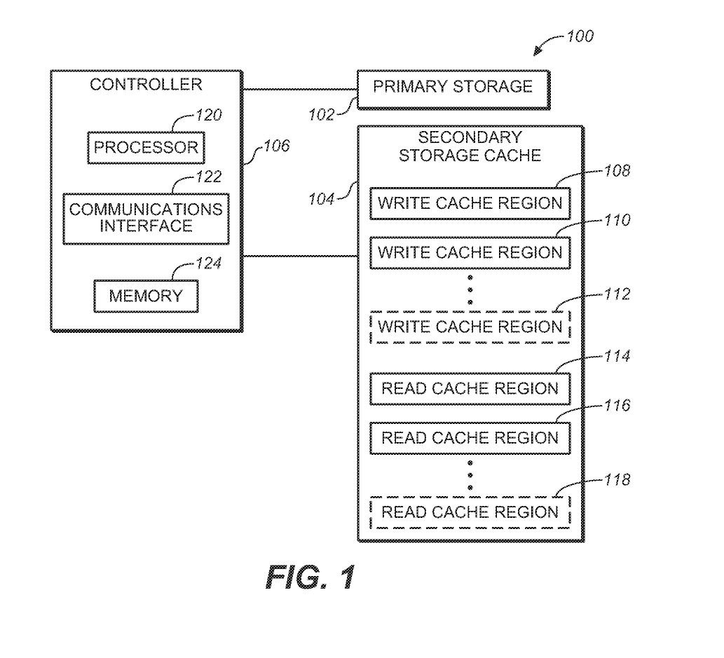

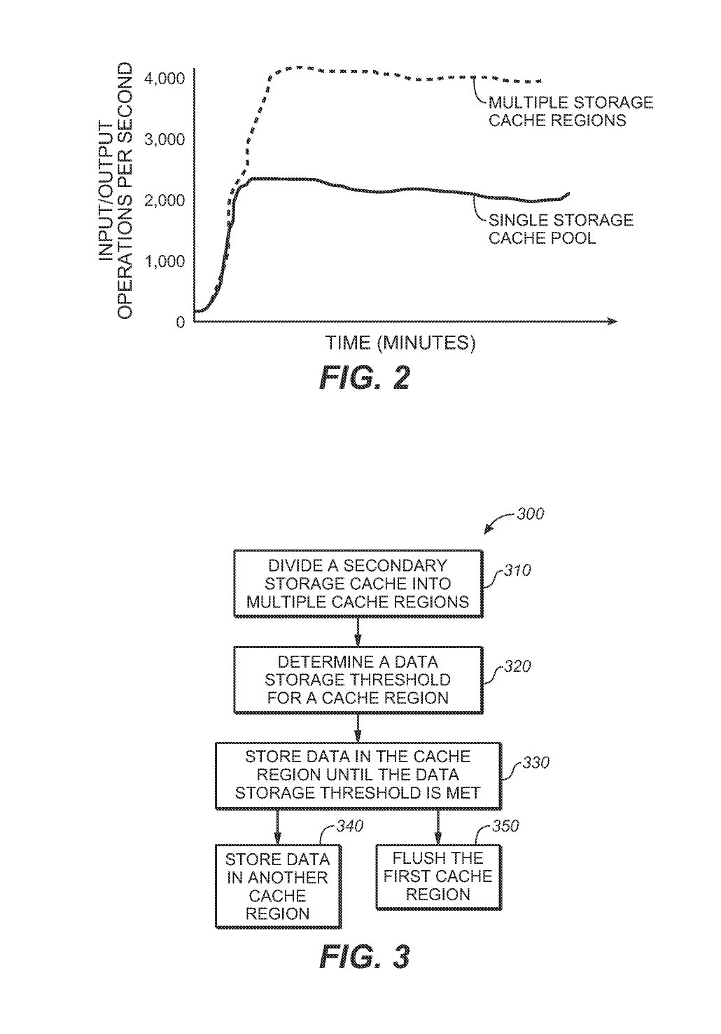

Referring generally to FIGS. 1 and 2, a system 100 is described. The system 100 includes one or more information handling system devices (e.g., servers) connected to a storage device (e.g., primary storage 102). In embodiments of the disclosure, primary storage 102 comprises one or more storage devices including, but not necessarily limited to: a disk drive (e.g., a hard disk drive), a redundant array of independent disks (RAID) subsystem device, a compact disk (CD) loader and tower device, a tape library device, and so forth. However, these storage devices are provided by way of example only and are not meant to be restrictive of the present disclosure. Thus, other storage devices can be used with the system 100, such as a digital versatile disk (DVD) loader and tower device, and so forth.

In embodiments, one or more of the information handling system devices is connected to primary storage 102 via a network such as a storage area network (SAN). For example, a server is connected to primary storage 102 via one or more hubs, bridges, switches, and so forth. In embodiments of the disclosure, the system 100 is configured so that primary storage 102 provides block-level data storage to one or more clients (e.g., client devices). For example, one or more client devices are connected to a server via a network, such as a local area network (LAN), and the system 100 is configured so that a storage device included in primary storage 102 is used for data storage by a client device (e.g., appearing as a locally attached device to an operating system (OS) executing on a client device).

The system 100 also includes a secondary storage cache 104 (e.g., comprising a cache pool). For instance, one or more information handling system devices include and/or are coupled with a secondary storage cache 104. The secondary storage cache 104 is configured to provide local caching to the information handling system device(s). The secondary storage cache 104 includes one or more data storage devices. For example, the secondary storage cache 104 includes one or more drives. In embodiments of the disclosure, one or more of the drives comprises a storage device such as a flash memory storage device (e.g., a solid state drive (SSD) and so forth). However, a SSD is provided by way of example only and is not meant to be restrictive of the present disclosure. Thus, in other embodiments, one or more of the drives can be another data storage device. In some embodiments, the secondary storage cache 104 provides redundant data storage. For example, the secondary storage cache 104 is configured using a data mirroring technique including, but not necessarily limited to: RAID 1, RAID 5, RAID 6, and so forth. In this manner, dirty write back data (write back data that is not yet committed to primary storage 102) is protected in the secondary storage cache 104.

In some embodiments, data stored on one drive of the secondary storage cache 104 is duplicated on another drive of the secondary storage cache 104 to provide data redundancy. In other embodiments, data is mirrored across multiple information handling system devices. For instance, two or more information handling system devices can mirror data using a drive included with each secondary storage cache 104 associated with each information handling system device. Additionally, data redundancy can be provided at both the information handling system device level and across multiple information handling system devices. For example, two or more information handling system devices can mirror data using two or more drives included with each secondary storage cache 104 associated with each information handling system device.

A cache based storage controller 106 is coupled with primary storage 102 and the secondary storage cache 104. The controller 106 is operatively coupled with the secondary storage cache 104 and configured to store data in the secondary storage cache 104 (e.g., data to be written back to primary storage 102). For example, the controller 106 facilitates writing to a write region of the secondary storage cache 104, as well as writing back data in the write region to primary storage 104. Deterioration in write performance as data is written back to primary storage 104 is generally referred to as write drop off, and the point at which write performance begins to deteriorate is generally referred to as a write cliff. Techniques of the present disclosure reduce write latency due to write drop off and improve write performance (e.g., improve write cliff handling). In embodiments of the disclosure, write back data is flushed from the secondary storage cache 104 to primary storage 102 once a characteristic (e.g., a predetermined threshold) is reached in occupied cache capacity. A cache pool of the secondary storage cache 104 is divided into two or more regions and data is written back from one region while data is stored in another region. In some embodiments, each region is the same size or at least substantially the same size, while in other embodiments various regions can be sized differently.

In embodiments of the disclosure, data storage in the secondary storage cache 104 is divided into one or more write cache regions and one or more read cache regions. A write cache region can comprise a write cache region 108, a write cache region 110, and possibly additional write cache regions (e.g., a write cache region 112). Further, a read cache region can comprise a read cache region 114, a read cache region 116, and possibly additional read cache regions (e.g., a read cache region 118). Depending upon a specific data environment, such as a file server environment, a web server environment, a database environment, an online transaction processing (OLTP) environment, an exchange server environment, and so forth, and/or depending upon the size of a cache pool, different numbers of write and/or read cache regions are provided, and the write and/or read cache regions are sized evenly, unevenly, and so forth. For example, in one embodiment, the write cache region 108 ranges between at least approximately one gigabyte (1 GB) and ten gigabytes (10 GB), the write cache region 110 ranges between at least approximately ten gigabytes (10 GB) and twenty-five gigabytes (25 GB), and the write cache region 112 ranges between at least approximately twenty-five gigabytes (25 GB) and seventy-five gigabytes (75 GB).

The read cache regions can also be divided into two, three, or more than three differently-sized regions in a similar manner. In some embodiments of the disclosure, the read cache regions are organized by one or more data usage characteristics (e.g., “hot,” “warm,” “cold,” and so forth). Data usage characteristics can be determined based upon, for example, hard drive usage characteristics. Further, a single write cache region can be implemented along with multiple read cache regions, a single read cache region can be implemented along with multiple write cache regions, multiple write cache regions can be implemented along with multiple read cache regions, and so forth. In embodiments of the disclosure, separation between different write cache pools is fixed (e.g., predetermined) and/or dynamic (e.g., determined at run time). For example, in a database storage application where a majority of storage operations comprise write operations (e.g., ninety percent (90%) write operations versus ten percent (10%) read operations), more write cache regions and/or larger write cache regions can be used with respect to fewer read cache regions and/or smaller read cache regions.

The controller 106 for system 100, including some or all of its components, can operate under computer control. For example, a processor 120 can be included with or in a controller 106 to control the components and functions of systems 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the systems 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

A processor 120 provides processing functionality for the controller 106 and can include any number of processors, micro-controllers, or other processing systems, and resident or external memory for storing data and other information accessed or generated by the system 100. The processor 120 can execute one or more software programs that implement techniques described herein. The processor 120 is not limited by the materials from which it is formed or the processing mechanisms employed therein and, as such, can be implemented via semiconductor(s) and/or transistors (e.g., using electronic integrated circuit (IC) components), and so forth.

The controller 106 includes a communications interface 122. The communications interface 122 is operatively configured to communicate with components of the system 100. For example, the communications interface 122 can be configured to transmit data for storage in the system 100, retrieve data from storage in the system 100, and so forth. The communications interface 122 is also communicatively coupled with the processor 120 to facilitate data transfer between components of the system 100 and the processor 120 (e.g., for communicating inputs to the processor 120 received from a device communicatively coupled with the system 100). It should be noted that while the communications interface 122 is described as a component of a system 100, one or more components of the communications interface 122 can be implemented as external components communicatively coupled to the system 100 via a wired and/or wireless connection.

The communications interface 122 and/or the processor 120 can be configured to communicate with a variety of different networks including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to be restrictive of the present disclosure. Further, the communications interface 122 can be configured to communicate with a single network or multiple networks across different access points.

The controller 106 also includes a memory 124. The memory 124 is an example of tangible, computer-readable storage medium that provides storage functionality to store various data associated with operation of the controller 106, such as software programs and/or code segments, or other data to instruct the processor 120, and possibly other components of the controller 106, to perform the functionality described herein. Thus, the memory 124 can store data, such as a program of instructions for operating the controller 106 (including its components), and so forth. It should be noted that while a single memory 124 is described, a wide variety of types and combinations of memory (e.g., tangible, non-transitory memory) can be employed. The memory 124 can be integral with the processor 120, can comprise stand-alone memory, or can be a combination of both. The memory 124 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth.

Referring now to FIG. 3, example techniques are described for operating a secondary storage cache comprised of multiple cache regions for a system that provides primary data storage to a number of clients. FIG. 3 depicts a process 300, in an example embodiment, for operating a secondary storage cache, such as the secondary storage cache 104 illustrated in FIGS. 1 and 2 and described above, where the secondary storage cache 104 is divided into a write cache region 108, a write cache region 110, and possibly additional write cache regions (e.g., a write cache region 112) and/or a read cache region 114, a read cache region 116, and possibly additional read cache regions (e.g., a read cache region 118). Techniques of the present disclosure can be used with both compressed and uncompressed write data stream formats in the write cache regions. Further, the techniques disclosed herein can be used in various cache based storage environments, including but not necessarily limited to: write data intensive environments such as sequential write data environments, random write data environments, a mixture of sequential and random write data environments, and so forth.

In the process 300 illustrated, a secondary storage cache is divided into multiple cache regions (Block 310). For example, with reference to FIGS. 1 and 2, the secondary storage cache 104 is divided into a write cache region 108, a write cache region 110, and possibly additional write cache regions (e.g., a write cache region 112); and/or the secondary storage cache 104 is divided into a read cache region 114, a read cache region 116, and possibly additional read cache regions (e.g., a read cache region 118). The multiple cache regions provide the ability for the controller 106 to operate at least one write region for a further write stream from the controller 106 when written data from another write region is flushed to primary storage 102 (e.g., to disk drives, logical volumes, and so forth). In this manner, storage firmware, for instance, can monitor and flush a filled written cache region to the primary storage 102 so that once a cache region is filled (or substantially filled) another cache region that has been flushed can be used in parallel to the first cache region to serve uninterrupted writes from the controller 106 to the cache storage pool.

A data storage threshold is determined for a cache region (Block 320). For instance, with continuing reference to FIGS. 1 and 2, a threshold can be determined for a write cache region 108, a write cache region 110, and/or a write cache region 112. In some embodiments, the threshold is predetermined, while in other embodiments, the threshold is dynamically determined (e.g., determined at run time). Further, different thresholds can be used for different cache regions (e.g., depending upon the size of a cache region). Next, data is stored in the cache region until the data storage threshold is met (Block 330). For example, with continuing reference to FIGS. 1 and 2, the controller 106 starts writing to the write cache region 108, the write cache region 110, and/or the write cache region 112 in parallel until one of the cache regions 108, 100, and/or 112 is filled.

The process 300 continues to store data in another cache region (Block 340) while the first cache region is flushed (Block 350). For instance, with continuing reference to FIGS. 1 and 2, the controller 106 continues to write to an unfilled cache region 108, 100, and/or 112, while the controller 106 writes back data from one or more of the cache region 108, 100, and/or 112 to primary storage 102. Then, when a data storage threshold is met for another cache region, the process 300 can store data in the first cache region that was previously flushed while the data for the second cache region is written back. In embodiments with N cache regions, where N is equal to two or more than two (e.g., N is equal to three, four, or more than four), data can be written back from all but one of the cache regions (e.g., from N−1 cache regions) as long as at least one cache region is available for further writes from the controller 106. In this manner, the controller 106 can continuously write data to the secondary storage cache 104.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In embodiments of the disclosure that manifest in the form of integrated circuits, the various blocks discussed in the above disclosure can be implemented as integrated circuits along with other functionality. Such integrated circuits can include all of the functions of a given block, system, or circuit, or a portion of the functions of the block, system or circuit. Further, elements of the blocks, systems, or circuits can be implemented across multiple integrated circuits. Such integrated circuits can comprise various integrated circuits including, but not necessarily limited to: a system on a chip (SoC), a monolithic integrated circuit, a flip chip integrated circuit, a multichip module integrated circuit, and/or a mixed signal integrated circuit. In embodiments of the disclosure that manifest in the form of software, the various blocks discussed in the above disclosure represent executable instructions (e.g., program code) that perform specified tasks when executed on a processor. These executable instructions can be stored in one or more tangible computer readable media. In some such embodiments, the entire system, block or circuit can be implemented using its software or firmware equivalent. In some embodiments, one part of a given system, block or circuit can be implemented in software or firmware, while other parts are implemented in hardware.

Although embodiments of the disclosure have been described in language specific to structural features and/or methodological acts, it is to be understood that the subject matter defined in the appended claims is not necessarily limited to the specific embodiments described. Although various configurations are discussed, the apparatus, systems, subsystems, components and so forth can be constructed in a variety of ways without departing from teachings of this disclosure. Rather, the specific features and acts are disclosed as embodiments of implementing the claims.

What is claimed is:

1. A system for continuously writing to a secondary storage cache, the system comprising:
a processor configured to divide a data storage region of a secondary storage cache into a first cache region and a second cache region and determine a data storage threshold for the first cache region; and
a memory configured to store the data storage threshold for the first cache region, the memory having computer executable instructions stored thereon, the computer executable instructions configured for execution by the processor to:
store data in the first cache region until the data storage threshold is met, and
store additional data in the second cache region while writing back the data stored in the first cache region to a primary storage device.

2. The system as recited in claim 1, wherein the first cache region and the second cache region are at least substantially the same size.

3. The system as recited in claim 1, wherein the first cache region ranges between at least approximately ten gigabytes (10 GB) and twenty-five gigabytes (25 GB), and the second cache region ranges between at least approximately twenty-five gigabytes (25 GB) and seventy-five gigabytes (75 GB).

4. The system as recited in claim 1, wherein the first cache region ranges between at least approximately one gigabyte (1 GB) and ten gigabytes (10 GB), and the second cache region ranges between at least approximately ten gigabytes (10 GB) and twenty-five gigabytes (25 GB).

5. The system as recited in claim 1, wherein the data storage threshold is predetermined.

6. The system as recited in claim 1, wherein the data storage threshold is determined at run time.

7. The system as recited in claim 1, wherein the system is fabricated in an integrated circuit.

8. A computer-readable storage medium having computer executable instructions for continuously writing to a secondary storage cache, the computer executable instructions comprising:
dividing a data storage region of a secondary storage cache into a first cache region and a second cache region;
determining a data storage threshold for the first cache region;
storing data in the first cache region until the data storage threshold is met; and
storing additional data in the second cache region while writing back the data stored in the first cache region to a primary storage device.

9. The computer-readable storage medium as recited in claim 8, wherein the first cache region and the second cache region are at least substantially the same size.

10. The computer-readable storage medium as recited in claim 8, wherein the first cache region ranges between at least approximately ten gigabytes (10 GB) and twenty-five gigabytes (25 GB), and the second cache region ranges between at least approximately twenty-five gigabytes (25 GB) and seventy-five gigabytes (75 GB).

11. The computer-readable storage medium as recited in claim 8, wherein the first cache region ranges between at least approximately one gigabyte (1 GB) and ten gigabytes (10 GB), and the second cache region ranges between at least approximately ten gigabytes (10 GB) and twenty-five gigabytes (25 GB).

12. The computer-readable storage medium as recited in claim 8, wherein the data storage threshold is predetermined.

13. The computer-readable storage medium as recited in claim 8, wherein the data storage threshold is determined at run time.

14. The computer-readable storage medium as recited in claim 8, the computer executable instructions further comprising:
determining a second data storage threshold for the second cache region;
storing the additional data in the second cache region until the second data storage threshold is met; and
storing data in the first cache region while writing back the additional data stored in the second cache region to the primary storage device.

15. A computer-implemented method for continuously writing to a secondary storage cache, the computer-implemented method comprising:
causing a processor to divide a data storage region of a secondary storage cache into a first cache region and a second cache region;
receiving a first data storage threshold for the first cache region;
storing data in the first cache region until the first data storage threshold is met;
storing additional data in the second cache region while writing back the data stored in the first cache region to a primary storage device;
determining a second data storage threshold for the second cache region;
storing the additional data in the second cache region until the second data storage threshold is met; and
storing data in the first cache region while writing back the additional data stored in the second cache region to the primary storage device.

16. The computer-implemented method as recited in claim 15, wherein the first cache region and the second cache region are at least substantially the same size.

17. The computer-implemented method as recited in claim 15, wherein the first cache region ranges between at least approximately ten gigabytes (10 GB) and twenty-five gigabytes (25 GB), and the second cache region ranges between at least approximately twenty-five gigabytes (25 GB) and seventy-five gigabytes (75 GB).

18. The computer-implemented method as recited in claim 15, wherein the first cache region ranges between at least approximately one gigabyte (1 GB) and ten gigabytes (10 GB), and the second cache region ranges between at least approximately ten gigabytes (10 GB) and twenty-five gigabytes (25 GB).

19. The computer-implemented method as recited in claim 15, wherein the data storage threshold is predetermined.

20. The computer-implemented method as recited in claim 15, wherein the data storage threshold is determined at run time.
